(19) United States
(12) Patent Application Publication
(10) Pub. No.: US 2019/0370904 A1
(43) Pub. Date: Dec. 5, 2019

(54) Methods and Systems for Strategically Managing Insurance and Reinsurance Policies on Risk Adjusted Basis

(71) Applicant: David Eichenblatt and Company, Atlanta, GA (US)

(72) Inventor: David L. Eichenblatt, Atlanta, GA (US)

(21) Appl. No.: 15/994,291

(22) Filed: May 31, 2018

(51) Int. Cl. G06Q 40/08; G06Q 10/10

(52) U.S. Cl. CPC G06Q 40/08; G06Q 10/10

(57) ABSTRACT

Systems and methods for providing insurance and reinsurance policies suitable for allocating a bundle(s) of warehoused risk and benefits for multi-year policies. The insurance originators present invention of the present invention offer an accumulated plurality of multi-year policies to reinsurers after an initial time period has elapsed. During the initial time period the insurance originators bear one-hundred percent of the risk while receiving one-hundred percent of the insurance premiums. After the initial time period the insurance originators share the risk and premiums with reinsurers on a pro-rata basis or disproportionate. Additionally, the present invention enables reinsurers the ability participate in one or a number of bundles of risks accumulated by the insurance company.

### FIELD OF THE INVENTION

The present invention relates to insurance and reinsurance suitable for allocating risk and benefits for multi-year policies. In particular, the present invention relates to systems and methods for offering a plurality of multi-year policies to reinsurers after an initial coverage time period of the policy has elapsed.

### BACKGROUND

Generally, insurance brokers offer insurance policies or risk transfer agreements to individuals and entities to allocate and pool risk. An insurance policy is a contract between the insurer and insuree or policyholder that is designed to hedge against a particular risk(s). In exchange for the protection offered by the policy, policyholders pay a premium to the insurer. Typically, the policy will cover an event(s) that could occur and with some level of uncertainty within a policy period. The uncertainty is the risk that the insurance policy protects against. For example, in a life insurance policy, the uncertainty is the time of death of a policy holder. In another example, the uncertainty in an auto insurance policy is if/when an accident will occur and what damages will be incurred during the accident within a policy period. When an event triggers a claim of coverage offered in the policy, the insurer will pay for an agreed upon portion of the cost of the claim for the policyholder. Most insurance policies are renewable annual policies that provide coverage for claims that occur throughout that year of coverage. This allows the possibility for an insurer to pay for zero claims, a single claim, or multiple claims on any single policy within a single contracted year. Regardless for the number of claims filed, the premiums for the policy remain the same for that year. Additionally, there are also, but much fewer, multi-year coverage policies that specify single or multiple claim occurrences during the policy period in which premiums can be paid upfront or over the multi-year period.

To protect against major claims events (e.g., natural disasters) insurance companies commonly purchase reinsurance policies for some of or all of the policies that the originating insurance company has sold to individual policy holders. The ultimate goal of reinsurance is to reduce exposure of the originating insurance company to loss incurred in a major claim event by passing part of the risk of loss to a reinsurer or a group of reinsurers. In particular, the insurance company pays, or shares, the premium to the reinsurance company in exchange for the reinsurance company sharing a percentage of the risk for the reinsured policies. The two basic types of reinsurance agreements are facultative reinsurance which is negotiated separately for each insurance policy that is reinsured and treaty reinsurance in which the reinsurer agrees to cover a specified share of all the insurance policies issued by the originating insurance company or a subset of policies that fall within a class or subclass per pre-agreed underwriting guidelines.

There are two main types of treaty reinsurance, proportional and non-proportional. Under proportional reinsurance, the share of the risk assumed by the reinsurer is defined by a percentage for each separate policy and the reinsurer will receive the stated percentage of the premiums for being obligated to pay the stated percentage of any claims. One form of non-proportional coverage is excess of loss Reinsurance. Under Excess of loss coverage, the reinsurer will only cover the losses that exceed the primary insurance company's retained limit. However, what makes this type of contract unique is that it is typically applied to catastrophic events. It can cover the insurance company either on a per occurrence basis of for all the cumulative losses within a specified period.

Under non-proportional reinsurance the liability of the reinsurer is based on the aggregate claims incurred by the originating insurance company such that such that the reinsurer will not get involved unless the total claims suffered by the originating insurer in a given period time exceeds a threshold value, with the exceeding value being covered by the reinsurer.

Other types of reinsurance include risk attaching basis, loss occurring basis, and claims-made basis. Under risk attaching basis, all policy claims that are established during the effective period of the reinsurance coverage will be covered, regardless of whether the losses occurred outside the coverage period. Conversely, no coverage will be given on claims that originated outside the coverage period, even if the losses occurred while the reinsurance contract is in effect. Loss occurring basis is a type of treaty coverage where the insurance company can claim all losses that occur during the reinsurance contract period. The important factor to consider is when the losses have occurred and not when the claims have been made. Claims-made basis is a policy covers all claims reported to an insurer within the policy period irrespective of when they occurred.

Typically, an originating insurance company originates and underwrites individual risks (e.g., policies) and concurrently reinsures out a majority of these risks to a group of reinsurers that signed up in advance under a quota share treaty arrangement up to an aggregate limit. Both the originating insurance company and the contracted reinsurers, in a typical quota share reinsurance treaty agreement, bear the risk of unknown specific or individual risks parameters for the duration of agreement period. Additionally, participating reinsurers are responsible for the agreed upon risk from the start of the policy through the end of the term of the policy. Thus, reinsurers sign up for an unknown specific risk pools of individual policies and number of risks or quantity to be sold. These added risks impact invested returns.

### SUMMARY

There is a need for improvements for how, when and combination of offerings of insurance policies are offered to reinsurers to optimally manage risk/reward from the current system that has not changed since the benches of Lloyds of London. The present invention is directed toward further solutions to address this need, in addition to having other desirable characteristics.

In accordance with example embodiments of the present invention, a computer implemented method for accumulating and allocating insurance risk is provided. The computer implemented method includes executing computer readable instructions, which when executed by a processor, are configured to perform functions that include aggregating, by an insurance originator. The plurality of insurance policies include an aggregate of risks covered by the plurality of insurance policies, an aggregate of premiums paid by policy holders of the plurality of insurance policies, a first term of coverage for a multi-term coverage of the plurality of insurance policies, and a second term of coverage for the multi-term coverage of the plurality of insurance policies. The method also includes purchasing, by the insurance originator, one or more reinsurance policies for a at least a portion of the plurality of insurance policies, covering, by the insurance originator, an entirety of the aggregate of risks during the first term of coverage, and receiving, by the insurance originator, the entirety of the aggregate of premiums during the first term of coverage. The method further includes covering, by the insurance originator, a first percentage of the aggregate risk during the second term of coverage and receiving, by the insurance originator, a second percentage of the aggregate premiums during the second term of coverage.

In accordance with aspects of the present invention, also includes covering, by a reinsurer of the one or more reinsurance policies, a third percentage of the aggregate risk for the portion of the plurality of insurance policies during the second term of coverage and receiving, by the reinsurer of the one or more reinsurance policies, a fourth percentage of the aggregate premiums for the portion of the plurality of insurance policies during the second term of coverage.

In accordance with aspects of the present invention, the first percentage and the third percentage combine for one-hundred percent and the second percentage and the fourth percentage combine for one-hundred percent. The first percentage and second percentage can be 10% and the third percentage and fourth percentage can be 90%. The first percentage and second percentage can be 20% and the third percentage and fourth percentage can be 80%. The first percentage and the second percentage can be disproportionate from the third percentage and the fourth percentage. The first term of coverage for a multi-term coverage of the plurality of insurance policies can be one year and the second term of coverage for the multi-term coverage of the plurality of insurance policies can be two years.

In accordance with aspects of the present invention, the method can further include bundling, by the insurance originator, the plurality of insurance policies into groups based on risk categories for selection by a reinsurer. Each bundle can include multiple risk categories with predetermined risk percentages for each of the policies included within the multiple risk categories. The plurality of insurance policies can be single occurrence policies. The plurality of insurance policies can be multiple occurrence policies. The aggregating, by an insurance originator, the plurality of insurance policies can be performed through a cloud computing infrastructure.

An insurance warehouse system is provided. The system includes a non-transitory computer readable medium having stored thereon computer readable instructions, which when executed by a processor, are configured to perform functions that include aggregating, by an insurance originator, a plurality of insurance policies. The plurality of insurance policies include an aggregate of risks covered by the plurality of insurance policies, an aggregate of premiums paid by policy holders of the plurality of insurance policies, a first term of coverage for a multi-term coverage of the plurality of insurance policies, and a second term of coverage for the multi-term coverage of the plurality of insurance policies. The functions also include purchasing, by the insurance originator, one or more reinsurance policies for at least a portion of the plurality of insurance policies, covering, by the insurance originator, an entirety of the aggregate of risks during the first term of coverage, and receiving, by the insurance originator, the entirety of the aggregate of premiums during the first term of coverage. The functions further include covering, by the insurance originator, a first percentage of the aggregate risk during the second term of coverage and receiving, by the insurance originator, a second percentage of the aggregate premiums during the second term of coverage.

In accordance with aspects of the present invention, the functions also include covering, by a reinsurer of the one or more reinsurance policies, a third percentage of the aggregate risk for the portion of the plurality of insurance policies during the second term of coverage and receiving, by the reinsurer of the one or more reinsurance policies, a fourth percentage of the aggregate premiums for the portion of the plurality of insurance policies during the second term of coverage.

In accordance with aspects of the present invention, the first percentage and the third percentage combine for one-hundred percent and the second percentage and the fourth percentage combine for one-hundred percent. The first percentage and second percentage can be 10% and the third percentage and fourth percentage can be 90%. The first percentage and second percentage can be 20% and the third percentage and fourth percentage can be 80%. The first percentage and the second percentage can be disproportionate from the third percentage and the fourth percentage.

In accordance with aspects of the present invention, the first term of coverage for a multi-term coverage of the plurality of insurance policies is one year and the second term of coverage for the multi-term coverage of the plurality of insurance policies is two years. The functions can also include bundling, by the insurance originator, the plurality of insurance policies into groups based on risk categories for selection by a reinsurer. Each bundle can include multiple risk categories with predetermined risk percentages for each of the policies included within the multiple risk categories. The plurality of insurance policies can be single occurrence policies. The plurality of insurance policies can be multiple occurrence policies.

### BRIEF DESCRIPTION OF THE FIGURES

These and other characteristics of the present invention will be more fully understood by reference to the following detailed description in conjunction with the attached drawings, in which:

FIG. 1 is an exemplary flow chart depicting the process for implementing the present invention;

FIG. 2 is an example table depicting profit margin and Internal Rate of Return (IRR) provided by implementing the present invention; and

FIG. 3 is a numeric example depicting example values when implementing the present invention; and

FIG. 4 is an exemplary computer architecture for implementing the present invention.

### DETAILED DESCRIPTION

An illustrative embodiment of the present invention relates to a methods and systems for managing insurance and reinsurance policies. The present invention provides an innovative structure for insurance that includes an originating insurer accumulating insurance policies (e.g., risks) and reinsuring the insurance policies through a specific combination of steps. Specifically, the steps include an originating insurer accumulating a package of multi-term (e.g., multi-year) insurance policies and then reinsuring out all, some, or a majority of the accumulated insurance policies after a predetermined period of time (e.g., a first year) of the policies has expired or a predetermined accumulated size. For example, the insurer will reinsure the accumulated policies after the first year (e.g., of a three-year policy) of the multi-year insurance policies has passed. In some embodiments, because the insurer bears all or a majority of the risk in the initial predetermined term, the insurer collects the entirety of the premiums paid toward the policies for that predetermined term. Thereafter, the premiums are shared between the insurer and the reinsures according to the percentage of risk bared by each party. For example, if the insurer reinsures out 90% of the risks associated with the policies, then the insurer will collect 10% of the premiums and the remaining premiums will be allocated to the reinsurers appropriately (e.g., using quota share treaty). These methods and systems for providing insurance and reinsurance provide a significant benefit to both the originating insurer and the reinsurers. The present invention also contemplates a disproportionate sharing of premium and risk and/or a bonus to the aggregating insurer.

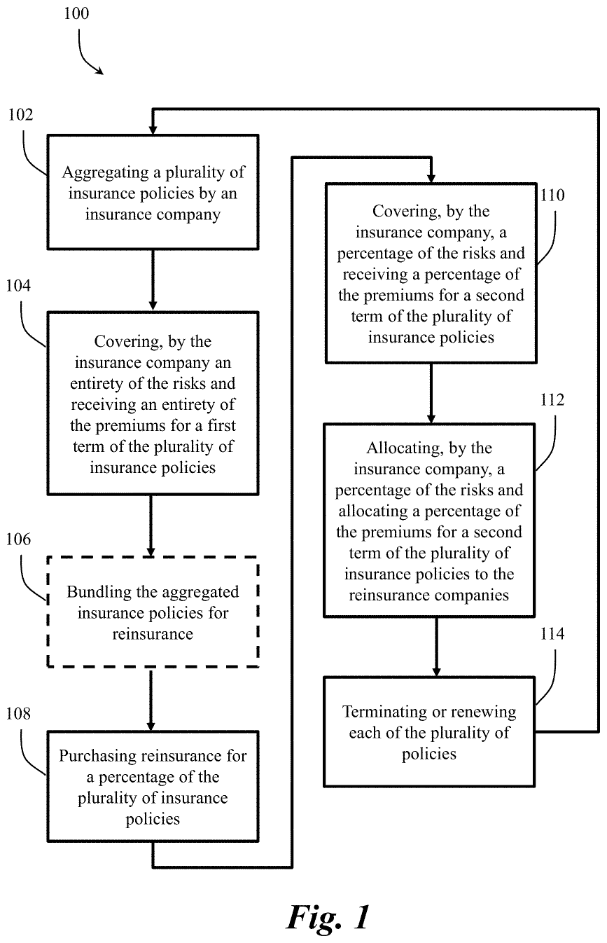

FIGS. 1 through 4, wherein like parts are designated by like reference numerals throughout, illustrate an example embodiment or embodiments of improved operation for managing insurance and reinsurance policies, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed in a manner still in keeping with the spirit and scope of the present invention.

FIG. 1 depicts an exemplary process 100 for an originating insurance company (or ceding company or primary insurer) to implement the present invention. Initially, the originating insurance company will offer insurance policies (contracts) to consumers. As would be appreciated by one skilled in the art, the insurance policies can include any combination of insurance policies and sub policies known in the art. For example, the policies can be life insurance, auto insurance, homeowner's insurance, hurricane insurance, fire/flood insurance, property or casualty insurance, financial insurance, surety insurance, etc. Typical policy terms can include, for example, coverage, policy period, limit of liability, coinsurance percentage, retention/deductible, premium, forms, endorsements, etc. The insurance policies will include the claims which the insurance company is required to pay, a length for the policy, predetermined terms within the length of the policy, etc. in exchange for payment of an agreed upon premium. In accordance with an example embodiment, the insurance policies can be multi-term policies with premiums proportionally paid over each term or all upfront. For example, the insurance policies can be three-year policies with premiums calculated paid upfront or divided over each year. As would be appreciated by one skilled in the art, any combination of terms, periods of time, premium payment schedules, etc. can be utilized without departing from the scope of the present invention.

At step 102, as insurance policies are sold, the policies are aggregated and packaged together by the originating insurance company. The policies can be packaged together based on any combination of predetermined criteria. For example, the policies can be packaged based on value of the risk/premiums, by the type of risks involved (e.g., life vs auto), by the severity of the risks (e.g., high risk vs low risk), by property types, by casualty types, or cross section of types to spread risk over one or many classes, or riskiness within a class, etc. Additionally, the insurance policies can be sold to customers through a number of direct and indirect channels and aggregated utilizing any combination of systems and methods known in the art. For example, the insurance company can sell directly, sell through brokerage networks, an agency relationship (e.g., a Managing General Agent (MGA)), etc., to aggregate policies.

All direct and indirect distribution channels follow the underwriting and other criteria of the aggregating originating insurance company. For example, the originating insurance company, working with an Managing General Agent (MGA), may or may not “pass the pen” to allow the MGA to bind the final policy. Typically, an application for insurance is made after a preliminary review to meet the underwriting requirements and then a full underwriting is performed as determined by the originating insurance company. Thereafter a binder is issued if accepted and to initiate coverage followed by delivery of the policy. As would be appreciated by one skilled in the art, the aggregated insurance policies do not need to be packaged together and instead can be categorized/arranged by pre-determined criteria (e.g., type of policy, policy value, property type (office, retail, industrial, hotel), by geography, by size, etc. or a combination thereof). This packaging can also be arranged to minimize risk, maximize return either individually/manually or with the inventions computer system using artificial intelligence or other algorithms.

At step 104, in accordance with an example embodiment, the insurance company covers an entirety of the risks involved within the aggregate policies for a first policy year term (period of time) or aggregating period. While being responsible for the entirety of the risk during the first policy year term or aggregating period, the insurance company will receive an entirety of the premiums for that first policy year term or aggregating period of the plurality of insurance policies. For example, for the first year of a multi-year policy the insurance company will cover the entirety of the risk involved in the policy while collecting an entirety of the insurance premiums for that same period. The insurance company would also monitor policies during the entire policy period including retirement and handle claims if needed. As would be appreciated by one skilled in the art, step 108 can also occur prior to the bundled insurance policies are fully completed.

In some embodiments process 100 can include an optional step 106 in which the aggregated insurance policies are bundled together for offering to reinsurance companies. At step 106 the process 100 creates a number of bundles of aggregate risks in different categories of risk. For example, the aggregated insurance policies from step 102 can be broken into a bundle of catastrophic insurance, a bundle of property insurance, a bundle of surety insurance, etc. Once the insurance policies are bundled they specific bundles can be provided to reinsurance company(ies) to elect choose how much of each bundle they want to provide reinsurance (e.g., as part of step 108). Additionally, the bundles can be provided to reinsurers as part of a highly diversify “fund” of insurance policies including selected percentages of risks for each bundle as a single package. In the insurance world the goal is to seek “uncorrelated” risks to reduce the overall risk of the reinsurance company. With the present invention, reinsurance can be provided in a less costly and efficient manner that brings liquidity and less friction for the reinsurance world by more finely allocating risk and reward associated in insurance.

As would be appreciated by one skilled in the art, the risk and reward combination of the bundles can be determined with any combination of computing devices, artificial intelligence programs or other algorithms, or user determination. After the first term (e.g., year one of a three-year policy) of the insurance policies has completed the risks and how many will be better known and mathematical models (e.g., linear programming, optimization techniques, A Monte Carlo simulation, Capital Asset Pricing Portfolio Analysis, etc.) can be utilized to from combination of risk and returns on a single category of risks or a combination of bundles of risk (correlated or uncorrelated).

In some embodiments, at step 106, the present invention can be utilized to create and accommodate added risk bearing entities other than traditional reinsurers. Currently there are ILS (Insurance Linked Securities), CLS (Casualty Linked Securities), etc. to allow non-reinsurance entities like hedge funds, pension funds, private equity to participate in risk just like reinsurers, but without the regulations. The present invention will enable can allow an insurance company sell to these and any other new risk bearing entity. In fact, new entities can be created such as syndications, family offices, etc. that the primary insurance company can buy reinsurance from them instead of them being a typical reinsurance company.

At step 108 the accumulated insurance policies can be reinsured, individually or in bulk, to reallocate the aggregated risks associated with the insurance policies. The insurance policies can be reinsured utilizing any combination of methods and systems known in the art. The primary method for reinsuring insurance policies will be a proportional reinsurance treaty and likely a quota share formula. The quota share of premiums and risk can be proportional or disproportional, as determined by the insurance company and reinsurers. A proportional quota share of the premiums and risk can be implemented as agreed upon by the insurance company and the reinsurers to have a proportional share of premiums to risk ratio. A disproportionate share of premium and risk allocation for the aggregating primary insurance company can be provided as reward to the aggregating insurance company for effort and risk of accumulating this aggregate package. The additional reward could also come in the form of an added bonus on top of a typical quota share. An example of a disproportionate scenario would be after the aggregating period for the originating insurer to receive 15% of the premium, yet share in 10% of any losses. A bonus could be in many forms such as simply the originating insurer being paid a onetime percentage or amount of collected premiums (like a transaction fee), and there after sharing proportionately in the remaining premium and losses.

Additionally, in accordance with an example embodiment, the insurance company can allow reinsurers to elect to insure the entirety of the packaged insurance policies or only a negotiated percentage of the packaged insurance policies. In one example, the insurance company originates and underwrites policies during a first policy term (e.g., year one) and reinsure out a significant majority (80%-90%) of these accumulated risks for the remaining policy term (e.g., years two and three of a three-year policy). Additionally, the first policy term and the remaining policy terms can be measured in any increments of time (e.g., days, weeks, years, etc.) and can be broken up into any increments over the course of an entirety of a policy. For example, the insurance policy can be in effect for a year with the originating insurance company premium and risk accumulation occurring in the first month while reinsuring an aggregated package including the insurance policy for the remaining eleven months of the twelve-month policy (one year).

At step 110, after the policies have been aggregated to a size determined by the primary company, the insurance company's responsibility for covering the risks can be reduced to a predetermined percentage for the balance of the insurance policies terms. While being responsible for a percentage of the risks the premiums collected by the insurance company can be reduced to the same percentage as the risks for the second/remaining term of the plurality of insurance policies. For example, the second/remaining term will include the second and third years in the multi-year policies and the insurance company will cover 10% of the risk and collect 10% of the premiums. As would be appreciated by one skilled in the art, the predetermined percentage can be any percentage agreed upon by the insurance company and the reinsurers.

At step 112 (subsequent to or simultaneously to step 110), after the first term has completed and the packaged insurance policies have been reinsured, the responsibility for covering a percentage of the risks for the aggregate insurance policies starts for the reinsurers. As the reinsurers sign on, then they collect premiums and are obligated to pay for any risks that trigger under the polies. The percentages of risks are predetermined values agreed upon between the insurance company and the reinsurers prior to initialization of the reinsurance (e.g., at step 108). Typically, when purchasing reinsurance, the primary insurance company will retain 10-20% of the involved risk and will reinsurers the balance (e.g., 90-80%) of the risk to the reinsurance companies. The reinsurers are responsible for covering the balance of the risks not covered by the insurance company. For example, if the insurance company is retaining covering 10% of the risks then the reinsurers are responsible for the remaining 90% of the risks. While being responsible for a percentage of the risks, the premiums provided to the reinsurers (e.g., via the insurance company) will typically be equal to the same percentage as the risks for the second term of the plurality of insurance policies but not necessarily in a disproportionate agreement. For example, for the second and third years in the three-year multi-year policies the insurance company will cover 90% of the risk and collect 90% of the premiums. As would be appreciated by one skilled in the art, any number of reinsurers can be utilized to cover the remaining balance of the risks not covered by the insurance company and each individual reinsurer will be compensated with a percentage of the premiums equal to the percentage of risk covered by that reinsurer.

At step 114 the insurance policies will expire and the insurance company will elect to terminate or renew each of the plurality of policies. For example, for a three-year policy, at the end of three years the policy will expire and either require the policy holder to initiate a new policy, terminate the policy, or the policy will automatically renew (based on terms of the policy) or automatically terminate. In accordance with an example embodiment, the insurance policies provided by the insurance company can be single occurrence policies such that the policy will terminate/expire upon filing and payment of a claim or expiration of the policy. At the conclusion of step 114, the process 100 can advance to step(s) 102/104 to renegotiate the terms of the insurance policies as well as the terms of the percentages to be covered by reinsurers. When policies are renewed, the premiums and coverage can be adjusted by the insurance company based on any combination of factors. Similarly, the quantity, percentage allocations, and involved parties in the reassurance will also be subject to change. Basically, after step 114, the cycle starts all over again with the originating insurer aggregating polices—either brand new and/or renewals under the same parameters, or revised program.

The combination of steps provided in process 100 depicted in FIG. 1 creates a specific combination of steps not previously implemented in convention insurance and reinsurance methods and systems. The process enables the ability to aggregate, manipulate and allocate risk and premiums (return) of most any policy type to achieve a desired risk and return profile, either manually or aided by computers. In particular, the present invention obtains insurance policies, packages the insurance policies and then reinsures the package of policies according to the predetermined periods agreed upon by the parties. In contrast, most reinsurance treaties (e.g., quota share), simple share in a predetermined number of unknown policies as they come in up to a limit (thus primary company never has risk of holding or warehousing a package of policies). As discussed, the present invention provides a benefit for reinsurers by the primary aggregating insurance company reducing their risk of unknown demand and enabling reinsurers to participate with a huge bundle of policies of known and aggregated risks (e.g., because factors revealed in the first term of the polies are known while the initial period of uncertainty was covered solely by the aggregating insurance company).

Implementing the process 100 depicted in FIG. 1, both the insurance company and the reinsurers benefit from the unique combination of steps and variables options. The insurance company benefits from originating and warehousing risks during the first predetermined period of time for the policies. Specifically, statistically, year one of a multi-year policy could have a significantly reduced risk of default such that if the predetermined period of time is the first year of a multi-year policy, the insurance company gains 100% of the paid premiums with little risk of default. Thereafter, the insurance company would retain a predetermined percentage of risk (e.g., 10%-20%) with a reduced percentage of the earned premiums in policy in the remaining time in the policies. This provides the insurance company with a reduced level of risk over some or all of the policies while holding a quota share of the risk with insurers. The net result would be a significant boost in profit (Profit Margin and Internal Rate of Return (IRR)) for insurers while bearing marginal risks, and perhaps net reduction.

For the reinsurer participating in the unique structure provided by the present invention, there are a number of reduced risk factors typically involved in providing reinsurance. In particular, by not being involved in the first predetermined term of the insurance policies, unknown and uncertain risks are reduced (e.g., each of the risks involved in the policies are identified after the predetermined period of time), the quantity of risks or assured volume of business/demand risks are reduced to a known quantity, no unknown underwriting risks, and the shortened term of exposure further reduces risk. The net result is a slightly lower profit margin for the reinsurer (due to not participating in the first predetermined period of time and associated unknowns), but now having the ability to immediately put a lot of capital to work with known number of risks and repeat many times and with some or all the lower associated risks.

In other words, the primary insurer has the risk, time, cost, capital and effort to aggregate a package of risks without any assured reinsurer prior commitment or support. The reinsurer now has significantly reduced a number of risks to be able to step up and put a sizable amount of capital to work at once without having the unknown, or risk, of how many policies, what they look like and many other specifics that are unknown in a typical quota share arrangement. In some embodiments, the present invention also offers the ability to offer the aggregated bundle in a number of risk formats with all or portion of the risk or select risks. Additionally, like a fund of funds, a reinsure can participate in this package of risk along with another aggregated bundle of risks to create the ideal combination of risks and returns, often in uncorrelated risks to further reduce the portfolio of risks in one transaction. This is in contrast to how reinsurance of insurance policies are typically offered to reinsurers and creates great efficiencies for reinsurers in a number of ways (possible reduced overhead, ability to effectively deploy large amounts of capital at once, time and underwriting savings, etc.). The present invention creates an efficient way for reinsurers to do business, at reduces risks, and slightly reduces profits. In short, the unique structure of the present invention provides profits that are extremely attractive, and enhanced for the primary carrier, and even more so on a risk adjusted basis while offering more options. Additionally, this new structure of originating/accumulating and reinsuring thus frees up surplus capital to repeat over and over again in shorter cycles with the same surplus capital originally committed by the primary carrier.

### Examples

In a simplified example, a Primary Insurance company obtained five insurance policies from different individuals for five separate auto insurance policies. In this example, each of the auto insurance policies are five-year policies. The premiums for the policies total $1,200 each year. In the first year of the five-year policy (e.g., first term), the Primary Insurance company will be responsible for 100% of the risk associated with each of the policies and will receive 100% of the premiums (e.g., $1,200 for each policy, totaling $6,000). After the first year, the Primary Insurance company will reinsure the second/remaining term of the multiyear policies (e.g., years two-five) to one or more reinsurance company). In this example, the Primary Insurance company reinsures out 80% of the policies while retaining 20% responsibility. Thereafter reinsurers will be responsible for 80% of the risks associated with the five policies for the remaining four years of their multiyear policies. In a quota share proportionate configuration, the reinsurers will receive 80% of the remaining premiums (e.g., $960 for each policy each of the remaining years, totaling $4,800 each year for a grand total of $19,200 for the remaining term for all five policies (e.g., remaining four years)) and the Primary Insurance company will receive 20% of the remaining premiums (e.g., $240 for each policy each of the remaining years, totaling $1,200 each year for a grand total of $4,800 for the remaining term for all five policies (e.g., remaining four years)) while covering 20% of the allocated risk. Over the five year period the Primary Insurance company would earn $10,800.

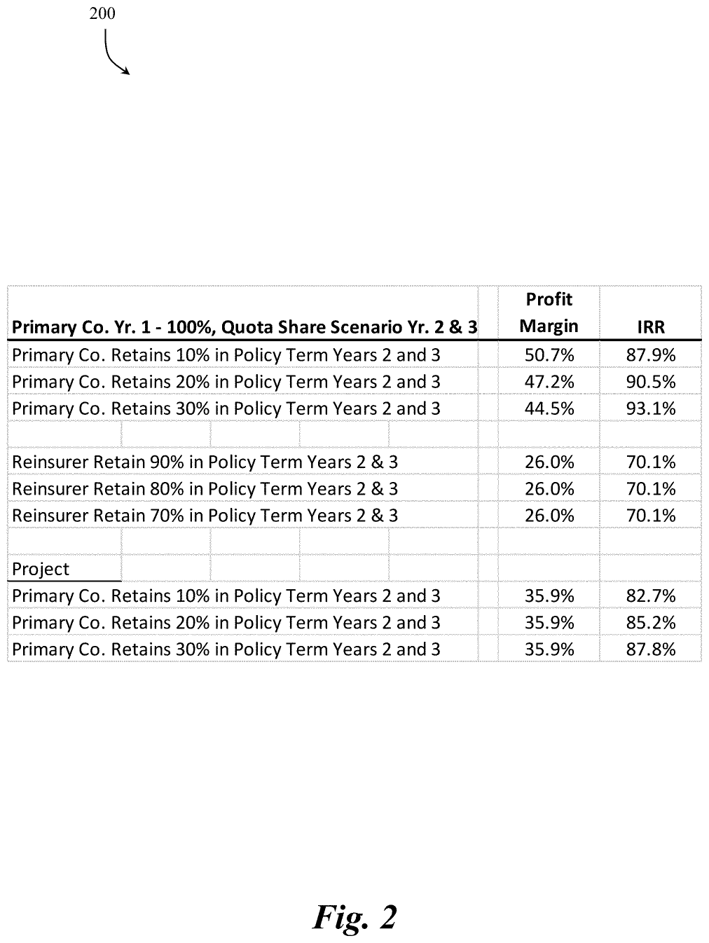

FIG. 2 depicts provides example returns provided to insurance originators and reinsurance companies working with the insurance originators when implementing the steps of the present invention. In particular, FIG. 2 depicts returns given for an insurance company in three different scenarios when implementing the present invention on three-year policies with a one year retention and reallocating risk to reinsurers in the remaining two years. The three scenarios depicted in FIG. 2 is the originating insurance company retaining either 10%, 20% or 30% of the risk after the first aggregating term (in which the originating insurance company was solely responsible). The chart identifies the profit margin and the IRR (or yield) for each of the scenarios for both the originating insurance company, the reinsurers, and the aggregate project/bundle as a whole.

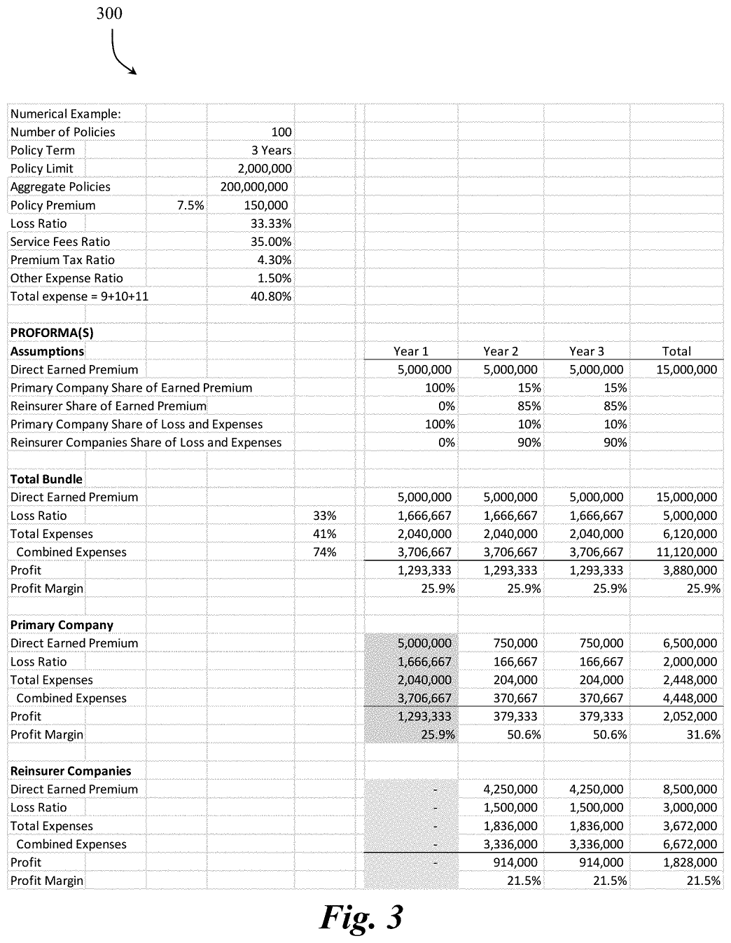

FIG. 3 depicts an exemplary numeric example of projected statistics utilizing the unique combination of steps for the present invention in a disproportionate configuration. A primary insurance carrier originates these policies one by one, directly or thru an intermediary, accumulates a bundle of risks. In the example of FIG. 3, the insurance company (Primary Company) has accumulated a one-hundred policy bundle with policy terms of three years. Once accumulated, this bundle of policies will share premiums and expenses, including losses, in any negotiated proportions for the remainder of the term with reinsurers—or other risk-taking entities. The policy limit for each policy is two-million to combine as an aggregate policy limit of two-hundred million. The policy premium for each policy is one-hundred-fifty thousand (7.5% of the limit—also known in the industry as rate on line). Additionally, the aggregate loss ratio of 35%, service fee ratio of 33.33%, premium tax ratio of 4.3%, and other expense ratio of 1.5% are identified respectfully, totaling 74.13% expenses for the policies (also known in the industry as the Combined Ratio). As would be appreciated by one skilled in the art, the numbers provided in FIG. 3 are for exemplary purposes only and could vary without departing from the scope of the present invention. As would be appreciated by one skilled in the art, the loss ratio, the expense ratio, and there total (combined ratio) differ with different risk classes.

As discussed with respect to FIG. 1, in accordance with an example embodiment of the present invention, the Primary Company will be entirely liable for 100% of the risk in the first predetermined period of time. In the numeric example provided in FIG. 3, the first predetermined period of time is the first year of the three-year policies (as shown in the Assumptions section in FIG. 3). Thus, based on the statistics provided in FIG. 3, the Primary Company earns one-hundred percent of the five million in direct premiums for bearing one-hundred percent of the share of loss and expenses for those policies during the first year.

The numeric example of FIG. 3 depicts a form of a quota/disproportional share reinsurance arrangement. As would be appreciated by one skilled in the art, however, any form of reinsurance arrangement can be implemented without departing from the scope of the present invention. There will be multiple reinsurer companies, or risk bearing entities, working with the Primary Company that originates, bundles and continues to manage all the policies thru policy termination for each individual policy. It is conceivable that some reinsurance companies take all 100 policies in the bundle, or perhaps exclude a few—depending on the primary company's parameters. Thus, the Primary Company would retain any policy risk not taken by a reinsurer. Continuing the numeric example in FIG. 3, after the first year, the Reinsurer Companies have a disproportionate share of the earned premium (15%/85%) than losses (10%/90%) in policy years 2 and 3 compared to the Primary Company. There are various variables and scenarios to negotiate for premium and expenses/losses sharing.

As a result of implementing the unique structure of the present invention, the Primary Company bears the risk of now taking some key reinsurance risk removed, and also is rewarded for this risk with a potentially disproportionately larger profit margin. In the example provided in FIG. 3, the primary company realized a 31.6% total profit margin compared to all reinsurer's total profit margin of 21.5%. Utilizing the same numbers in a conventional quota share proportional methodology, both the Primary Company and Reinsurer would have the same profit margin of 25.9%. This example depicts a disproportionate ratio.

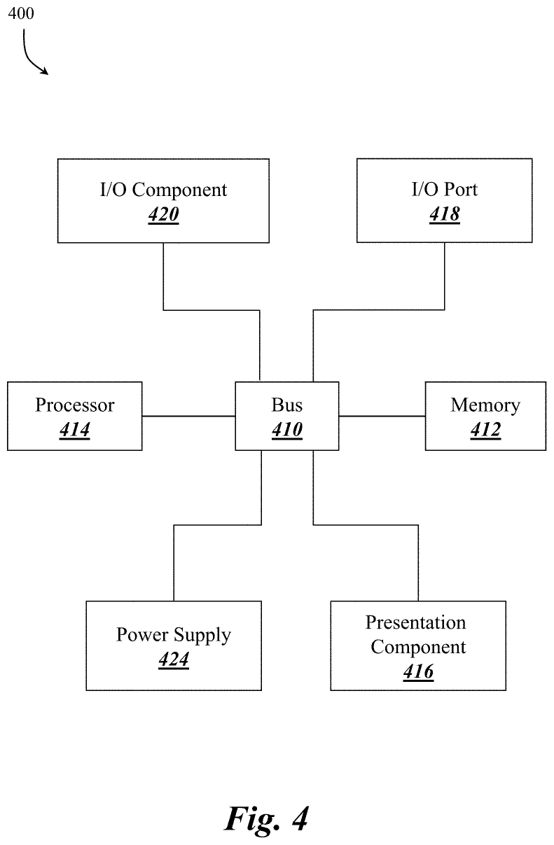

In accordance with an example embodiment of the present invention, the unique combination of steps provided in FIG. 1, and as discussed with respect to FIGS. 2 and 3, can be implemented on a computing device. For example, the present invention can be implemented on a centralized network or cloud computing infrastructure and users (e.g., insurance providers, reinsurers, policy purchasers, etc.) can interact with the present invention through personal computing devices via a web interface, website, application, etc. Any suitable computing device can be used to implement the methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 400 is depicted in FIG. 4. The computing device 400 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 400 is depicted for illustrative purposes, embodiments of the present invention may utilize any number of computing devices 400 in any number of different ways to implement a single embodiment of the present invention. Accordingly, embodiments of the present invention are not limited to a single computing device 400, as would be appreciated by one with skill in the art, nor are they limited to a single type of implementation or configuration of the example computing device 400.

The computing device 400 can include a bus 410 that can be coupled to one or more of the following illustrative components, directly or indirectly: a memory 412, one or more processors 414, one or more presentation components 416, input/output ports 418, input/output components 420, and a power supply 424. One of skill in the art will appreciate that the bus 410 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 400 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the computing device 400.

The memory 412 can include computer-storage media in the form of volatile and/or nonvolatile memory. The memory 412 may be removable, non-removable, or any combination thereof. Exemplary hardware devices are devices such as hard drives, solid-state memory, optical-disc drives, and the like. The computing device 400 can include one or more processors that read data from components such as the memory 412, the various I/O components 416, etc. Presentation component(s) 416 present data indications to a user or other device. Exemplary presentation components include a display device, speaker, printing component, vibrating component, etc.

The I/O ports 418 can enable the computing device 400 to be logically coupled to other devices, such as I/O components 420. Some of the I/O components 420 can be built into the computing device 400. Examples of such I/O components 420 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer implemented method for accumulating and allocating insurance risk, the computer implemented method comprising:
executing computer readable instructions, which when executed by a processor, are configured to perform functions that include:
aggregating, by an insurance originator, a plurality of insurance policies comprising:
an aggregate of risks covered by the plurality of insurance policies;
an aggregate of premiums paid by policy holders of the plurality of insurance policies;
a first term of coverage for a multi-term coverage of the plurality of insurance policies; and
a second term of coverage for the multi-term coverage of the plurality of insurance policies;
purchasing, by the insurance originator, one or more reinsurance policies for a at least a portion of the plurality of insurance policies;
covering, by the insurance originator, an entirety of the aggregate of risks during the first term of coverage;
receiving, by the insurance originator, the entirety of the aggregate of premiums during the first term of coverage;
covering, by the insurance originator, a first percentage of the aggregate risk during the second term of coverage; and
receiving, by the insurance originator, a second percentage of the aggregate premiums during the second term of coverage.

2. The method of claim 1, further comprising:
covering, by a reinsurer of the one or more reinsurance policies, a third percentage of the aggregate risk for the portion of the plurality of insurance policies during the second term of coverage; and
receiving, by the reinsurer of the one or more reinsurance policies, a fourth percentage of the aggregate premiums for the portion of the plurality of insurance policies during the second term of coverage.

3. The method of claim 1, wherein the first percentage and the third percentage combine for one-hundred percent and the second percentage and the fourth percentage combine for one-hundred percent.

4. The method of claim 1, wherein the first percentage and second percentage are 10% and the third percentage and fourth percentage are 90%.

5. The method of claim 1, wherein the first percentage and second percentage are 20% and the third percentage and fourth percentage are 80%.

6. The method of claim 1, wherein the first percentage and the second percentage are disproportionate from the third percentage and the fourth percentage.

7. The method of claim 6, wherein:
the first term of coverage for a multi-term coverage of the plurality of insurance policies is one year; and
the second term of coverage for the multi-term coverage of the plurality of insurance policies is two years.

8. The method of claim 1, further comprising bundling, by the insurance originator, the plurality of insurance policies into groups based on risk categories for selection by a reinsurer.

9. The method of claim 8, wherein each bundle includes multiple risk categories with predetermined risk percentages for each of the policies included within the multiple risk categories.

10. The method of claim 1, wherein the plurality of insurance policies are single occurrence policies.

11. The method of claim 1, wherein the plurality of insurance policies are multiple occurrence policies.

12. The method of claim 1, wherein the aggregating the plurality of insurance policies is performed through a cloud computing infrastructure.

13. A insurance warehouse system, the system comprising:
a processor;
a non-transitory computer readable medium having stored thereon computer readable instructions, which when executed by the processor are configured to perform functions that include:
aggregating, by an insurance originator, a plurality of insurance policies comprising:
an aggregate of risks covered by the plurality of insurance policies;
an aggregate of premiums paid by policy holders of the plurality of insurance policies;
a first term of coverage for a multi-term coverage of the plurality of insurance policies; and
a second term of coverage for the multi-term coverage of the plurality of insurance policies;
purchasing, by the insurance originator, one or more reinsurance policies for at least a portion of the plurality of insurance policies;
covering, by the insurance originator, an entirety of the aggregate of risks during the first term of coverage;
receiving, by the insurance originator, the entirety of the aggregate of premiums during the first term of coverage;
covering, by the insurance originator, a first percentage of the aggregate risk during the second term of coverage; and
receiving, by the insurance originator, a second percentage of the aggregate premiums during the second term of coverage.

14. The system of claim 13, further comprising:
covering, by a reinsurer of the one or more reinsurance policies, a third percentage of the aggregate risk for the portion of the plurality of insurance policies during the second term of coverage; and
receiving, by the reinsurer of the one or more reinsurance policies, a fourth percentage of the aggregate premiums for the portion of the plurality of insurance policies during the second term of coverage.

15. The system of claim 13, wherein the first percentage and the third percentage combine for one-hundred percent and the second percentage and the fourth percentage combine for one-hundred percent.

16. The system of claim 13, wherein the first percentage and second percentage are 10% and the third percentage and fourth percentage are 90%.

17. The system of claim 13, wherein the first percentage and second percentage are 20% and the third percentage and fourth percentage are 80%.

18. The system of claim 13, wherein the first percentage and the second percentage are disproportionate from the third percentage and the fourth percentage.

19. The system of claim 18, wherein:
the first term of coverage for a multi-term coverage of the plurality of insurance policies is one year; and
the second term of coverage for the multi-term coverage of the plurality of insurance policies is two years.

20. The system of claim 13, further comprising bundling, by the insurance originator, the plurality of insurance policies into groups based on risk categories for selection by a reinsurer.

21. The system of claim 21, wherein each bundle includes multiple risk categories with predetermined risk percentages for each of the policies included within the multiple risk categories.

22. The system of claim 13, wherein the plurality of insurance policies are single occurrence policies.

23. The system of claim 13, wherein the plurality of insurance policies are multiple occurrence policies.
